(19) United States
(12) Patent Application Publication
(10) Pub. No.: US 2016/0188872 A1
(43) Pub. Date: Jun. 30, 2016

(54) METHOD AND SYSTEM FOR RUNTIME INJECTION OF SECURE APPLICATIONS

(71) Applicant: OpenPeak Inc., Boca Raton, FL (US)

(72) Inventor: Andrew James Dobson, McKinney, TX (US)

(21) Appl. No.: 14/811,158

(22) Filed: Jul. 28, 2015

Related U.S. Application Data
(60) Provisional application No. 62/033,142, filed on Aug. 5, 2014.

(51) Int. Cl. G06F 21/52; G06F 21/51

(52) U.S. Cl. CPC G06F 21/52; G06F 21/51; G06F 2221/033

(57) ABSTRACT

A method and system of runtime injection for a secure application are described herein. During runtime of the secure application, a conventional request from the secure application can be intercepted. The intercepted conventional request can be modified such that the request is unrecognizable to an unsecure application, which can create a secure request. In addition, the secure request can be passed to a system process to enable the system process to process the secure request.

### CROSS-REFERENCE TO RELATED APPLICATIONS

This patent application claims priority to U.S. Provisional Patent Application No. 62/033,142, filed on Aug. 5, 2014, which is incorporated herein by reference in its entirety.

### FIELD OF TECHNOLOGY

The present description relates to methods and systems for controlling the interactions of applications and more particularly, for controlling the interactions of secure applications.

### BACKGROUND

In an effort to increase productivity, many employers allow their workers to conduct business related to the employer on their personal mobile devices. In some cases, employers also provide some of their employees with company-issued mobile devices. In either arrangement, an employer understands that a single device may include sensitive data related to that employer in addition to data that is personal to the employee. Several advances have been made in an effort to protect an employer's data in these circumstances. For example, OpenPeak Inc. of Boca Raton, Fla. has developed solutions that enable a mobile device to include both enterprise and personal data but that isolate the enterprise data from the personal data. As part of these solutions, an employee may download secure applications that may be used to conduct transactions related to the enterprise.

### SUMMARY

A method of runtime injection for a secure application is described herein. During runtime of the secure application, a conventional request from the secure application can be intercepted. The intercepted conventional request can be modified such that the request is unrecognizable to an unsecure application, thereby creating a secure request. The secure request can be passed to a system process to enable the system process to process the secure request. In addition, a secure return can be received from the system process in response to the secure request, and the secure return can be converted to a conventional return. The conventional return can be passed to the secure application for processing by the secure application.

As an example, passing the secure request to the system process can include passing the secure request to the system process by calling a conventional object that would normally handle the conventional request. In one embodiment, it can be determined that the secure application has been initiated, and in response to the determination, one or more conventional variables associated with the secure application can be replaced with a corresponding proxy. The replaced conventional variables can correspond to system services that are available to the secure application. In another example, replacing the variables associated with the secure application can occur prior to any conventional code of the secure application being executed. The corresponding proxy can be, for example, an invocation handler that holds an instance of the conventional variable.

In another embodiment, an instance of a secure framework can be loaded as part of a process of the secure application, and the secure framework can be responsible for modifying the conventional request to create the secure request. As an example, the secure request can be unrecognizable to the unsecure application by conforming to a predetermined secure namespacing scheme. Other examples of how a secure request can be unrecognizable to an unsecure application will be shown below.

A method of creating a secure application to enable runtime injection of the secure application is also described herein. This method can include the step of receiving a target application that includes conventional components and a manifest that presents information about the conventional components of the target application in which one of the conventional components is an application class. An override class can be implemented in the target application, and the override class may be configured to extend the application class. The override class can be further configured to cause a secure framework to be loaded and secure runtime hooks to be set in place prior to the initiation of the application class to enable the runtime injection of the secure application. The override class can be declared in the manifest of the target application, thereby creating the secure application.

In one arrangement, the conventional components can be modified to create corresponding secure components that are not compatible with unsecure applications but are able to be registered with a system framework with which the secure application will interact. This method can also include the step of uploading the secure application to an application repository for distribution to a computing device. As another example, implementing the override class in the target application can be performed without access to the source code of the target application.

A computing device that supports one or more secure applications and one or more unsecure applications is also described herein. The computing device can include an input/output (I/O) device that can be configured to receive input for launching one of the secure applications. The device can also include memory that is configured to store instructions that are related to the operation of the secure applications. A processing unit that is configured to execute the instructions related to the operation of the secure applications may also be part of the computing device. The processing unit can be further configured to cause one or more conventional requests from the secure application to be intercepted after the secure application has been launched through the I/O device and to cause the intercepted conventional request to be converted into a secure request that is unrecognizable to the unsecure applications supported by the computing device. The processing unit can also be configured to cause the secure request to be passed to a system process to enable the system process to process the secure request.

The processing unit can be further configured to cause a secure return that is received in response to the secure request to be converted into a conventional return and to cause the conventional return to be received by the secure application. As an example, the processing unit can be configured to cause the secure request to be passed to the system process by causing a conventional object to be called with the secure request in which the secure request is a modified application programming interface (API). As another example, the processing unit can be further configured to cause conventional fields associated with system services available to the secure application to be replaced with a corresponding proxy for purposes of converting the conventional requests into secure requests.

Another computing device is described herein. This computing device can include an interface that is configured to receive a target application and a processing unit that is configured to cause an override class to be implemented into the target application to convert the target application into a secure application. The override class can be configured to initiate a process in which a secure framework is loaded and secure runtime hooks are set in place to enable runtime injection of the secure application after the application is launched.

In one arrangement, the target application may include a manifest and a plurality of conventional components, and one of the conventional components may be an application class. The processing unit can be further configured to cause the override class to be declared in the manifest. As an example, the conventional components of the manifest may also include intents, and the processing unit can be further configured to cause the intents of the manifest to be modified for purposes of intent resolution. In another embodiment, the processing unit can be further configured to cause the integration of adapt instructions into the target application as part of the conversion of the target application to the secure application to ensure that the override class is launched prior to the application class.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for the distribution of applications to computing devices.

FIG. 2 illustrates an example of a block diagram of the system architecture of a computing device that is configured to practice the subject matter described herein.

FIG. 3 illustrates an example of a block diagram of a management unit.

FIG. 4 illustrates an example of a method for creating a secure application to enable runtime injection of the secure application.

FIG. 4 illustrates an example of a method for creating a secure application to enable runtime injection of the application.

FIG. 5 illustrates an example of a method of runtime injection for a secure application.

FIG. 6 illustrates an example of a signal-flow diagram of runtime injection for a secure application.

FIG. 7 illustrates another example of a signal-flow diagram of runtime injection for a secure application.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described. The word “among,” as it is used throughout this description, should not necessarily be interpreted as requiring exchanges or interaction among three or more applications, irrespective of grammar rules. The word “a” is not necessarily limited to a singular instance of something, as it may mean one or more.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged (directly or indirectly) between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The term “computer readable storage medium” is defined as one or more components that are configured to store instructions that are to be executed by one or more processing units.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” or “processor” is defined as one or more components that execute sets of instructions, and the components may be disparate parts or part of a whole unit and may not necessarily be located in the same physical location.

The terms “memory,” “memory element” or “repository” are defined as one or more components that are configured to store data, either on a temporary or persistent basis. The term “shared memory” is memory, a memory element or a repository that is accessible (directly or indirectly) by two or more applications or other processes. An “interface” is defined as a component or a group of components that enable(s) a device to communicate with one or more different devices, whether through hard-wired connections, wireless connections or a combination of both. An “input/output device” is defined as a device that is configured to at least receive input from a user or a machine that is intended to cause some action or other effect on a component with which the input device is associated.

The term “file system” is defined as an abstraction that is used to organize, store and retrieve data. The term “secure application” is defined as an application that has been modified or enhanced from its original form to restrict communications between the application and unauthorized programs, applications or devices and to restrict operation of the application based on policy or to alter, augment or add features associated with the operation of the application (or any combination thereof) or—in the case of the application not being modified—an application that is part of a secure workspace that is protected from data exchanges with applications that are part of a personal or an unsecure workspace. An “enterprise application” is defined as an application that is associated with an enterprise such that a user interacting with the application is performing an operation of behalf of the enterprise during at least some part of the time during the interaction, though not necessarily for each interaction. A “target application” is defined as an application that has been selected for conversion into a secure application. An “unsecure application” is defined as an application that has not undergone the modification required to convert the application into a secure application and, as such, is unable to obtain data from a secure application in view of an obfuscation scheme employed by that secure application. A personal application may be an unsecure application. A “virtual machine” is defined as a platform-independent execution environment that emulates a physical machine.

The term “personal workspace” is defined as a workspace, profile or partition that is configured to contain the personal content and unsecure applications or other unsecure programs associated with a user of a computing device on which the personal workspace sits. The term “secure workspace” is defined as a workspace, profile or partition that is configured to contain secure content, secure applications and other secure programs and requires some form of authentication to be accessed.

The term “runtime” is defined as at least the portion of time that an application or other program is executing. A “secure namespacing scheme” is a namespacing scheme that is designed to be unpredictable and for use only by secure applications. The term “secure request” is a request that has been modified to conform to a secure namespacing scheme or some other obfuscation process designed to protect the request from being processed by an unsecure application or other program. In addition, a “secure return” is defined as a return that conforms to a secure namespacing scheme or some other obfuscation process designed to protect the return from being processed by an unsecure application or other program. The term “manifest” is defined as a file that contains information about an application that is designed to enable the application to interact with a system that supports the application.

As explained earlier, solutions have been developed that enable a mobile device to include both enterprise and personal data but that isolate the enterprise data from the personal data. Accordingly, it may be useful to provide ways to create secure applications and to ensure that the data exchanges of these secure applications are protected from unsecure applications on the mobile device.

In view of this need, a method and system of runtime injection for a secure application are described herein. During runtime of the secure application, a conventional request from the secure application can be intercepted. The intercepted conventional request can be modified such that the request is unrecognizable to an unsecure application, which can create a secure request. In addition, the secure request can be passed to a system process to enable the system process to process the secure request.

Through this arrangement, secure applications can be generated for use in secure workspaces on computing devices. Moreover, in view of the runtime hooking that occurs, minimal modifications are needed to convert the original application to a secure application.

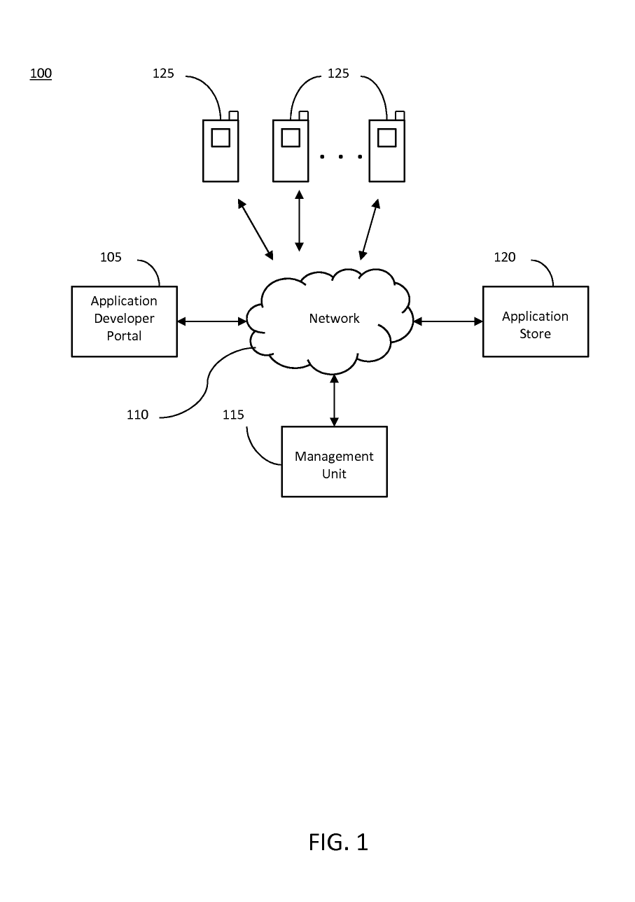

Referring to FIG. 1, a system 100 that is useful for distributing applications is shown. In one arrangement, the system 100 can include an application developer portal 105, a network 110, a management unit 115, an application store or repository 120 and any number of computing devices 125. Although not shown here, the system 100 can include multiple application developer portals 105, networks 110, management units 115 or application stores 120. Also, while FIG. 1 implies that the computing device 125 is a mobile unit, the system 100 and the processes described herein may be relevant to and practiced with fixed computing devices.

The application developer portal 105 can present an interface that enables developers of applications to upload their applications for eventual publication in the application store 120. The application store 120, as is known in the art, can enable users of the portable computing devices 125 to install such published applications on their devices 125. In some cases, the applications from the application developers may be directed to the management unit 115 prior to being published in the application store 120. Through the management unit 115, the applications may be modified such that they are more conducive for operation on behalf of an enterprise or other organization. For example, the applications may be converted into secure applications, a process in which certain intercepts may be imposed on an application during runtime such that functions of the application may be restricted, enhanced or otherwise modified in some way, depending on input from the enterprise. Examples of this process will be presented below. An application that has been selected for conversion into a secure application by the management unit 115 (or some other component) may be referred to as a target application. In addition, an application that has not undergone the process of conversion into a secure application may be referred to as a non-secure or unsecure application.

Once a secure application is generated, it can be published in the application store 120, similar to a conventional application that has been published. Because the application store 120 accepts and offers secure applications, it may also be referred to as a secure application store 120. In some cases, a secure application store 120 may be configured to accept and offer only secure applications, although in other scenarios it may accept and offer both secure and unsecure applications. In addition, a secure application store 120 may have limited access to a certain group of users, such as those associated with a particular enterprise, or it may be open to the general public. If access is limited to the secure application store 120, an accessing user may be required to provide some form of authentication before being granted such access. Moreover, the applications that are made available through the secure application store 120 are not necessarily required to be received from the application developer portal 105, as other sources may be used to provide applications to the secure application store 120.

The network 110 can facilitate communications between any of the components of the system 100. As mentioned earlier, there may be multiple networks 110 in the system 100, and each network 110 may be composed of various types of components to support wireless or wired communications (including both). In addition, the network(s) 110 may be configured to support both local or wide area communications (or both). In one arrangement, the management unit 115 may serve as a remote portal that can be used to manage certain features or operations of the computing devices 125, including the secure applications that may be installed in the computing devices 125.

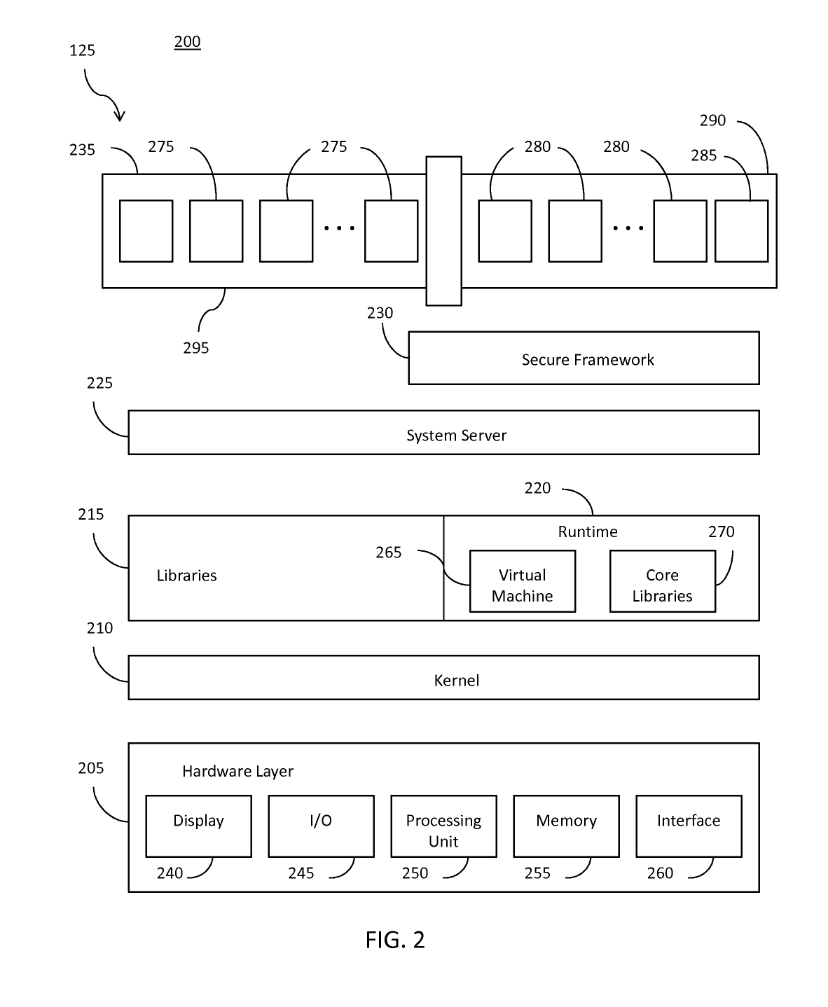

Referring to FIG. 2, an example of a block diagram 200 of the system architecture of a computing device 125 is shown. In this arrangement, the computing device 125 can include a hardware layer 205, a kernel layer 210 and a libraries layer 215, which may include a plurality of native libraries. This architecture may also include a runtime environment 220, a system server 225, a secure framework 230 and an application layer 235.

In one arrangement, the hardware layer 205 may include any number and type of hardware components, such as one or more displays 240, one or more input/output (I/O) devices 245, one or more processing units 250 and any suitable type and number of memory devices 255 and interfaces 260. Examples of the I/O devices 245 include speakers, microphones, physical keypads, etc. In addition, the display 240 can serve as an I/O device 245 in the form of a touch-screen display. The interfaces 260 can be configured to support various types of communications, including wired or wireless and through any suitable type of standards and protocols.

In addition, the runtime environment 220 can support any suitable number of virtual machines 265 and core libraries 270, and the system server 225 can serve as an abstraction for the underlying layers for the applications in the application layer 235 and can provide numerous system services for the applications. In this example, the application layer 235 may include any number of unsecure applications 275 and any number of secure applications 280, one of which may be a core secure application 285. The secure framework 230 can function similar to that of a conventional framework, but the secure framework 230 can facilitate the encapsulation of a number of secure applications 280 to selectively restrict their data exchanges with the unsecure applications 275. In particular, the secure framework 230 can be configured to intercept and modify certain calls from the secure applications 280, prior to passing them to the system server 225. Because the unsecure applications 275 may not be privy to the modification technique, the unsecure applications 275 may be unable to obtain data from a secure application 280. Additional detail on this process will be presented below.

In many cases, the unsecure applications 275 are associated with the personal data of a user of the computing device 125. In contrast, the secure applications 280 are typically associated with confidential or otherwise sensitive information that belongs to or is associated with an enterprise or some other organization, and the user of the device 125 may work for such an entity. In one arrangement, a virtual partition may be created on the computing device 125 in which the secure applications 280 (and the secure core application 285) are part of a secure workspace 290, and the unsecure applications 275 are part of a personal workspace 295. In certain cases, a user may be required to provide authentication information, such as a password, PIN or biometric data, to gain access to the secure workspace 290 or to any individual or group of secure applications 280. In addition, the user may launch both secure applications 280 and unsecure applications 275 through the I/O device 245.

As mentioned earlier, one of the secure applications 280 may be a secure core application 285. The core application 285 may include any number of files that can make up any number of shared libraries. As an example, the files may be Java Archive (JAR) files, and when the core application 285 is loaded, these JAR files may be copied to an appropriate repository of the computing device 125. As such, the core application 285 can be responsible for providing a certain number of classes that can make up the shared libraries, which can be made available to the secure applications 280. These classes, in some cases, can be substituted for certain system classes that would be normally used. In one arrangement, the secure framework 230 can be one or more libraries that are delivered by the core application 285.

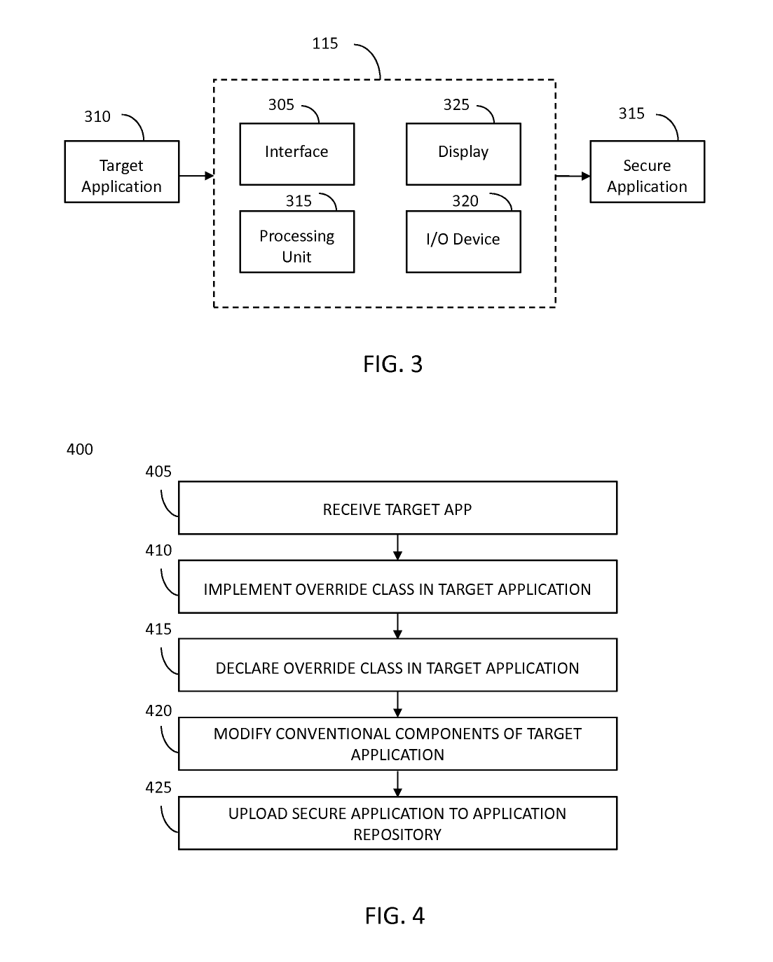

Referring to FIG. 3, an example of a block diagram of the management unit 115 of FIG. 1 is shown. In this example, the management unit 115 may include an interface 305 that can be configured to receive a target application 310. The interface 305 can be any suitable combination of components that are designed to receive the target application 310 from the application developer portal 105 via the network 110. The management unit 115 can also include one or more processing units 315, one or more I/O devices 320, one or more displays 325 and any suitable type and number of memory components. As will be explained below, when the target application 310 is received, the management unit 115 can be used to convert the target application 310 into a secure application 280, which may be eventually installed on the computing device 125.

Referring to FIG. 4, an exemplary method 400 for creating a secure application to enable runtime injection of the application is shown. The method 400, however, may include additional or even fewer steps or processes in comparison to what is illustrated in FIG. 4. Moreover, the method 400 is not necessarily limited to the chronological order that is shown in FIG. 4. In describing the method 400, reference may be made to FIGS. 1, 2 and 3, although it is understood that the method 400 may be practiced with any other suitable systems and components and may take advantage of other suitable processes.

At step 405, a target application can be received, and an override class can be implemented in the target application, as shown at step 410. The override class can be declared in the target application, thereby creating a secure application, as shown at step 415. At step 420, conventional components of the target application may be modified to create corresponding secure components. In addition, at step 425, the secure application can be uploaded to an application repository for distribution to a computing device. Examples of these steps will be presented below.

In one arrangement, the management unit 115 can receive the target application 310, which can include conventional components and a manifest that presents information about the conventional components. A conventional component in this sense is a component that already exists in the target application and is capable of being modified as part of the process in converting the target application 310 into a secure application 280. Examples of conventional components include intents and intent filters, activities, services and content providers. Another example of a conventional component is an application class, which, as is known in the art, is a base class for maintaining global variables.

Once the target application 310 is received, an override class can be implemented in the target application 310, as mentioned earlier. For example, an application tag in the manifest can be modified to cause the override class to extend the pre-existing application class. As part of this process, in one embodiment, the override class can be declared in the manifest of the target application 310. In view of this configuration, at launch, the override class can be loaded prior to any of the conventional components. Any adapt code can be integrated into the target application 310 to ensure that this process occurs. As will be explained further below, the override class can cause an override class loader, which may be part of the secure core application 285, to be injected into the normal system operation.

Steps can also be taken to modify other conventional components of the target application 310. For example, any number of the intents, intent filters, activities, services and content providers recited in the manifest of the target application 310 may be modified or decorated to create corresponding secure components. The conventional components that are modified may be components that are well-known in view of the design of the target application 310 in relation to an operating system of the computing device 125. In view of this decoration process, these corresponding secure components may be in compliance with a predetermined namespacing scheme, which can be used to ensure the security of the interprocess communications of the secure applications 280. The technique of modifying the conventional components in the manifest is also useful for intent resolution. At this point, or alternatively when the override class is implemented or declared, the target application 310 may be considered to be a secure application 280.

In one arrangement, the secure application may be uploaded to an application repository, such as an electronic application store. The computing device 125 may be configured to access the repository and can download and install the secure application 280. Once installed, steps can be taken to enable runtime injection of the secure application 280, as will be explained below.

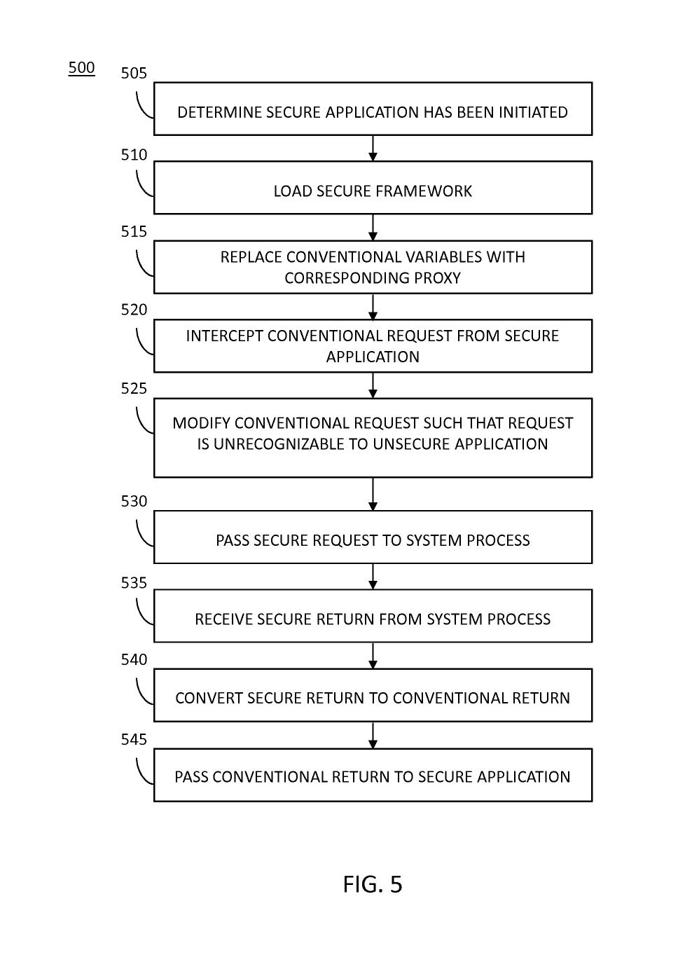

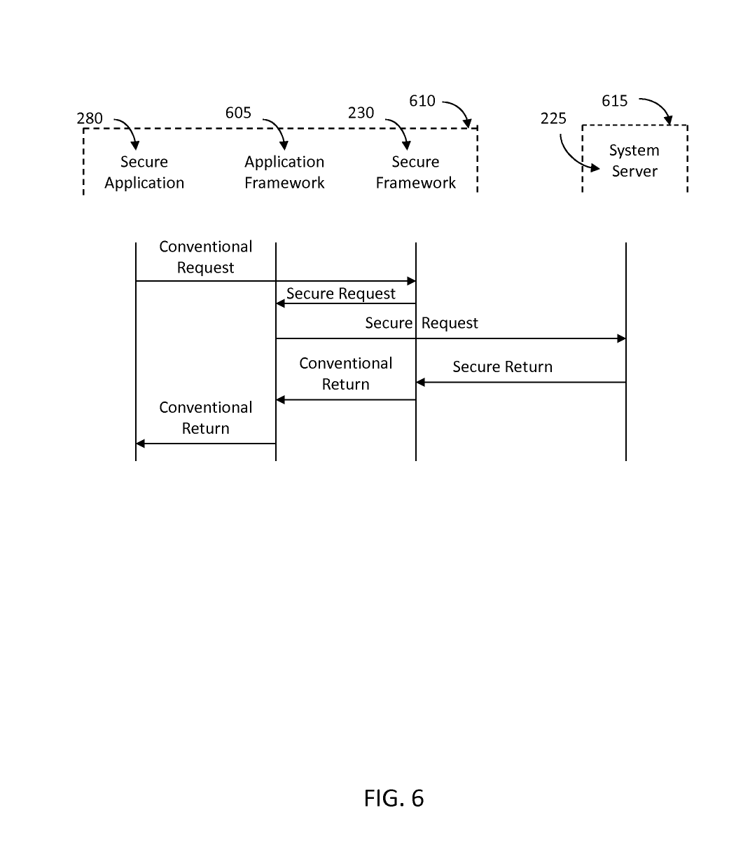

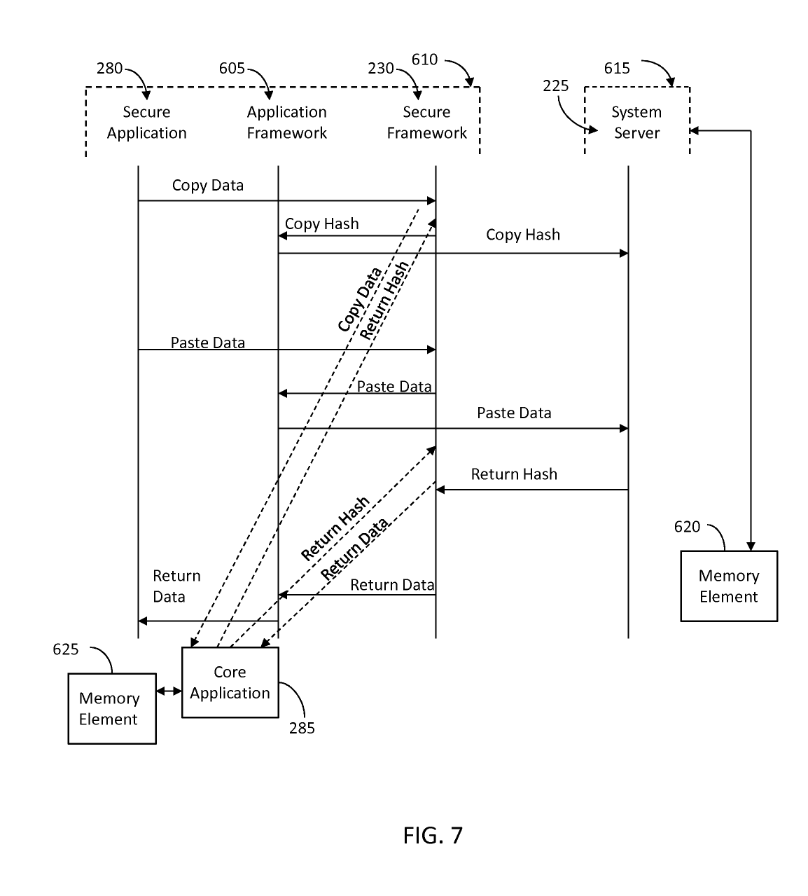

Referring to FIG. 5, a method 500 for runtime injection is illustrated. The method 500, however, may include additional or even fewer steps or processes in comparison to what is illustrated in FIG. 5. Moreover, the method 500 is not necessarily limited to the chronological order that is shown in FIG. 5. In describing the method 500, reference may be made to FIGS. 1, 2 and 3, although it is understood that the method 400 may be practiced with any other suitable systems and components and may take advantage of other suitable processes. Reference may also be made to FIGS. 6 and 7, which show examples of message exchange between several components, to help explain the method 500, although other exchange models may be applicable here.

At step 505, it can be determined that a secure application has been initiated, and at step 510, an instance of a secure framework can be loaded as part of the process of the secure application. In response to the initiation of the secure application, one or more conventional variables associated with the secure application may be replaced with a corresponding proxy, as shown at step 515.

For example, when the secure application 280 is installed on the computing device 125, the (decorated) secure components can be registered with the system server 225 or some other element of the system of the computing device 125. In addition, as previously noted, the core application 285 of the computing device 125 may include any number of libraries that may be shared among the secure applications 280, including the secure framework 230.

When a secure application 280 is initiated, the override class can be initiated prior to the application class, and the override class can be responsible for loading the shared libraries of the core application 285, one of which may be an override class loader. Moreover, as part of this flow, an instance of the secure framework 230 can be loaded as part of the process of the initiated secure application 280. As such, the override class loader can enable the secure application to access the shared libraries of the core application 285, even though the secure application 280 may have been initially unaware of them.

As part of this initial set-up of the secure application 280, the override class loader can also enable runtime hooks to be set up for the secure application 280. As an example, the override class loader can load an encryption manager that can establish runtime encryption hooks and a service manager that can set up other runtime hooks for any number of system services. In one arrangement, this procedure can cause one or more conventional variables of the application framework of the process for the secure application 280 to be replaced with a corresponding proxy. In one arrangement, the replaced conventional variables can correspond to system services that are available to the secure application 280. For example, any number of well-known application programming interfaces (API) that are related to system services can be parsed and certain variables of these APIs can be replaced with a corresponding proxy. As another example, the variables of the APIs that are replaced may be fields that serve as the binder or interface between the application space of the secure application 280 and the system server 225 or other system process.

Continuing with the example, the corresponding proxy can be an invocation handler that is an object of the same type as the replaced field, and the invocation handler can be a generic object that can implement all or at least a substantial portion of the classes of the operating system of the computing device 125. As part of this configuration, the invocation handler can process various methods and can provide a single method of invoke. Moreover, the invocation handler encapsulates the replaced field, and the invocation handler is integrated into the application process for the secure application 280. As such, the corresponding proxy can be considered a different instance of the replaced field and, as will be explained below, can enable the decoration of the affected API calls and their delivery to the system server 225.

As can be seen, this process can enable runtime hooks to be implemented for the APIs of the secure application 280. Any number of the system services may be targeted during this step, including all of them or only a portion thereof. Once the initial relevant classes have been loaded and the runtime hooks have been set, the override class loader may selectively defer to the application class. In view of this selective deferment, there are some instances where the override class loader may load other classes from the core application 285 during runtime in place of system classes. As will be explained below, the classes loaded by the override class loader may facilitate the modification or decoration of calls from the secure application 280. Additional information on the override class loader and its operation can be found in U.S. patent application Ser. No. 14/614,866, filed on Feb. 2, 2015, which is incorporated herein by reference.

Referring back to the method 500, during runtime of the secure application, a conventional request from the secure application can be intercepted, as shown at step 520. At step 525, the intercepted conventional request can be modified such that the request is unrecognizable to an unsecure application, thereby creating a secure request. At step 530, the secure request can be passed to a system process to enable the system process to process the secure request. In response to the secure request, a secure return may be received from the system process, as shown at step 535. At step 540, the secure return may then be converted to a conventional return, and the conventional return can be passed to the secure application for processing by the secure application, as shown at step 545.

Referring to FIGS. 6 and 7, examples of this process will be presented. In the first example, which is illustrated in FIG. 6, a user may have initiated a secure application 280 and may wish to share some type of content, such as with another secure application 280. In the second example, which is shown in FIG. 7, a user may wish to copy some content from a secure application 280 and paste that content in the same secure application 280, although such content may be pasted in a different secure application.

Referring to FIG. 6, a representation of a message exchange between a secure application 280, an application framework 605, a secure framework 230 and a system server 225 is illustrated. In this example, the secure application 280, the application framework 605 and the secure framework 230 may be considered to be part of an application process 610. In addition, the system server 225 may be part of a system process 615, a process that is separate from the application process 610.

In this example, as previously noted, the user may wish to share some content from the secure application 280. Accordingly, a conventional request may be generated by the secure application 280, which normally would be facilitated by the application framework 605. A conventional request, in this context, is simply a request that conforms with a normal request for a system service and has not yet been decorated or modified. In view of the runtime hooks, the conventional request can be intercepted and directed to the secure framework 230, which can modify or decorate the conventional request. This decoration can convert the conventional request into a secure request, which can conform to a predetermined secure namespacing scheme. For example, the relevant component of the conventional request may be appended with an affix or some other morpheme to create the secure request. At this point, only applications that are privy to the secure namespacing scheme, such as the secure applications 280, may be able to respond to the secure request. Accordingly, these communications may be modified such that they are obfuscated from or unrecognizable by unsecure applications.

Once the secure request is created, the secure framework 230 can make the same API call to the encapsulated field, thereby sending the secure request to the application framework 605. The application framework 605 can then send the secure request across to the system server 225, which can process the secure request. For example, one or more other secure applications 280 may have previously declared certain component filters in their manifests that would enable them to respond to the secure request for sharing content. As such, the system server 225 can send to the secure framework 230 a secure return that is related to the secure applications 280 that can handle the request.

As an option, the secure framework 230 can convert the secure return to a conventional return or can perform additional filtering or other steps. In one arrangement, the secure return can be converted to a conventional return by removing the appended affix from the secure return, a process that may also be referred to as undecorating. The secure framework 230 can pass the conventional return to the application framework 605, which can send it to the secure application 280 for processing. As an example, if more than one secure application 280 can handle the request, a chooser dialog or some other user interface element can be presented to the user to permit the user to select which secure application 280 should process the request. If the user selects one of the presented secure applications 280, that secure application 280 can launch, and the calls associated with this interaction can be decorated and undecorated as described above, with the secure framework 230 overseeing such manipulation.

Referring to FIG. 7, an exemplary copy and paste operation is presented. In this example, a user may be operating a secure application 280 and may copy some data that is associated with the secure application 280. In view of the description above, the copy call may be intercepted by the secure framework 230, which can modify the call by re-directing it to the core application 285. In response, the core application 285 can store the copied data in a memory element 625, which may be a memory element with restricted access. In one arrangement, the data copied in the memory element 625 can be mapped to enable correlation, which may be helpful if multiple copy operations are permitted in the computing device 125.

In one embodiment, the core application 285 can return a hash of an identifier to the secure framework 230. For example, the identifier can be a timestamp of the current time, although other identifiers may be employed here. The secure framework 230 can then send the hash of the identifier to the encapsulated field or interface of the application framework 605, which can then send it to the system server 225. The system server 615 can then copy the hash of the identifier in a memory element 620, in accordance with standard operating procedure for a copy API. Thus, the copy request may be modified because the true data intended to be copied is intercepted and replaced with a hash of an identifier. Moreover, the request is unrecognizable by an unsecure application 275 because an unsecure application 275 that attempts a paste operation will be returned the hash of the identifier, not the data from the secure application 280. Accordingly, the request can be decorated in ways that are different from appending the components, as described above.

At a later time, the user may wish to perform a paste operation, either from the same secure application 280 from where the copy feature was initiated or a different secure application 280. In this example, the paste originates from the secure application 280 that initiated the corresponding copy operation.

In this example, the paste operation can be intercepted by the secure framework 230 and can be directed to the application framework 605, which can send the paste call to the system server 225. The system server 225 can retrieve the hash of the identifier from the memory element 620 and can return it to the secure framework 230. In response, the secure framework 230 can return the hash of the identifier to the core application 285, which can then retrieve the actual copied data from the memory element 625. Subsequently, the core application 285 can return the actual copied data to the secure framework 230, which can then pass the data to the application framework 605. At this point, the application framework 605 can return the data to the secure application 280 to complete the paste operation.

As noted earlier, there are certain system services that may be hooked to render the affected communications or operations taking place from being recognizable by unauthorized processes, such as unsecure applications. While many well-known API calls may be targeted in this scheme, some system services may be unaffected. That is, this process may apply to only certain calls to and from the secure application 280, while the remaining ones are permitted to proceed in conventional fashion.

One skilled in the art will appreciate that the processes described herein may be under the direction of, facilitated by or at least assisted by one or more of the processing units 250 of FIG. 2. Other circuitry and hardware components of the computing device 125 may also provide such support.

While various embodiments have been described above, it should be understood that they have been presented by way of example only, and not limitation. It will be understood by those skilled in the relevant art(s) that various changes in form and details may be made therein without departing from the spirit and scope of the subject matter as defined in the appended claims. Accordingly, the breadth and scope of the present subject matter should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of runtime injection for a secure application:
during runtime of the secure application, intercepting a conventional request from the secure application;
modifying the intercepted conventional request such that the request is unrecognizable to an unsecure application, thereby creating a secure request; and
passing the secure request to a system process to enable the system process to process the secure request.

2. The method according to claim 1, further comprising:
receiving a secure return from the system process in response to the secure request;
converting the secure return to a conventional return; and
passing the conventional return to the secure application for processing by the secure application.

3. The method according to claim 1, wherein passing the secure request to the system process comprises passing the secure request to the system process by calling a conventional object that would normally handle the conventional request.

4. The method according to claim 1, further comprising:
determining that the secure application has been initiated;
in response to the determination, replacing one or more conventional variables associated with the secure application with a corresponding proxy, wherein the replaced conventional variables correspond to system services that are available to the secure application.

5. The method according to claim 4, wherein replacing the variables associated with the secure application occurs prior to any conventional code of the secure application being executed.

6. The method according to claim 5, wherein the corresponding proxy is an invocation handler that holds an instance of the conventional variable.

7. The method according to claim 1, further comprising loading an instance of a secure framework as part of a process of the secure application and wherein the secure framework is responsible for modifying the conventional request to create the secure request.

8. The method according to claim 1, wherein the secure request is unrecognizable to the unsecure application by conforming to a predetermined secure namespacing scheme.

9. A method of creating a secure application to enable runtime injection of the secure application, comprising:
receiving a target application that includes conventional components and a manifest that presents information about the conventional components of the target application, wherein one of the conventional components is an application class;
implementing an override class in the target application that is configured to extend the application class, wherein the override class is further configured to cause a secure framework to be loaded and secure runtime hooks to be set in place prior to the initiation of the application class to enable the runtime injection of the secure application; and
declaring the override class in the manifest of the target application, thereby creating the secure application.

10. The method according to claim 9, further comprising modifying the conventional components to create corresponding secure components that are not compatible with unsecure applications but are able to be registered with a system framework with which the secure application will interact.

11. The method according to claim 9, further comprising uploading the secure application to an application repository for distribution to a computing device.

12. The method according to claim 9, wherein implementing the override class in the target application is performed without access to the source code of the target application.

13. A computing device that supports one or more secure applications and one or more unsecure applications, comprising:
an input/output device that is configured to receive input for launching one of the secure applications;
memory that is configured to store instructions that are related to the operation of the secure applications; and
a processor that is configured to execute the instructions related to the operation of the secure applications;
wherein the processor is further configured to:
cause one or more conventional requests from the secure application to be intercepted after the secure application has been launched through the input/output device;
cause the intercepted conventional request to be converted into a secure request that is unrecognizable to the unsecure applications supported by the computing device; and
cause the secure request to be passed to a system process to enable the system process to process the secure request.

14. The computing device according to claim 13, wherein the processor is further configured to:
cause a secure return that is received in response to the secure request to be converted into a conventional return; and
cause the conventional return to be received by the secure application.

15. The computing device according to claim 13, wherein the processor is configured to cause the secure request to be passed to the system process by causing a conventional object to be called with the secure request, wherein the secure request is a modified application programming interface (API).

16. The computing device according to claim 13, wherein the processor is further configured to cause conventional fields associated with system services available to the secure application to be replaced with a corresponding proxy for purposes of converting the conventional requests into secure requests.

17. A computing device, comprising:
an interface that is configured to receive a target application; and
a processor that is configured to cause an override class to be implemented into the target application to convert the target application into a secure application, wherein the override class is configured to initiate a process in which a secure framework is loaded and secure runtime hooks are set in place to enable runtime injection of the secure application after the application is launched.

18. The computing device according to claim 17, wherein the target application includes a manifest and a plurality of conventional components and one of the conventional components is an application class, wherein the processor is further configured to cause the override class to be declared in the manifest.

19. The computing device according to claim 18, wherein the conventional components of the manifest also include intents and the processing unit is further configured to cause the intents of the manifest to be modified for purposes of intent resolution.

20. The computing device according to claim 17, wherein the received target application includes an application class and wherein the processor is further configured to cause the integration of adapt instructions into the target application as part of the conversion of the target application to the secure application to ensure that the override class is launched prior to the application class.
